(19) United States
(12) Patent Application Publication
(10) Pub. No.: US 2009/0029113 A1
(43) Pub. Date: Jan. 29, 2009

(54) Structural composite material structures with a metal surface add-on to increase their electrical conductivity

(75) Inventors: Pedro Ramon Garcia Sanchez, Madrid (ES); Desiderio Sanchez-Brunete Alvarez, Madrid (ES); Jose Luis Cifuentes Martin, Madrid (ES); Jose Sanchez Gomez, Madrid (ES)

Correspondence Address: LADAS & PARRY LLP, 26 WEST 61ST STREET, NEW YORK, NY, 10023, US

(73) Assignee: AIRBUS ESPANA, S.L..

(21) Appl. No.: 11/904,629

(22) Filed: Sep. 27, 2007

(30) Foreign Application Priority Data
Jul. 27, 2007 (ES) 200702108

(51) Int. Cl. B05D 5/12; B32B 15/04; B32B 3/10; B05D 1/02

(52) U.S. Cl. 428/172; 428/457; 428/209; 427/123

(57) ABSTRACT

Structural component of non-conductive composite material, particularly for aircraft (panel (1), frame (3), stringer (2), etc), that comprises in the surface a metal-type layer (4), such that the mentioned structural component together with the remaining metallized structural components can provide the aircraft with the sufficient conductive metal mass. According to a second aspect of the invention, a metallization method is proposed in the manufacture of a structural component, particularly for aircraft, made of composite material, which method allows the geometric configuration of the add-on by applying it in an extensive or limited manner to predetermined contours by means of using templates. This constructive feature allows creating integrated electric circuits in the airplane structure by means of creating independent tracks with different widths and thicknesses.

### FIELD OF THE INVENTION

The present invention relates to a structural component, particularly for aircraft, made of composite material with a metal add-on conferring electrical conductivity properties to it, as well as to a process for manufacturing it.

### BACKGROUND OF THE INVENTION

The use of composite materials in aircraft structural components (panels, frames, stringers, skins, hulls, etc.), mainly of carbon fiber, is currently increasing. For this reason, the conductive metal mass has started to disappear in state-of-the-art aircraft. This metal mass is necessary in an aircraft to carry out the functions of signal, electric current return or power conductor, aircraft grounding, so that there is a return path for the leakage currents, as an antenna ground plane, for lightning protection, etc.

The problem that is then set forth is that of providing the aircraft structure made of composite material with the necessary conductive metal mass.

Part of said functions are currently covered by means of co-curing and co-gluing continuous and expanded metal films and meshes, glued or riveted metal plates, or even metal fibers mixed with the reinforcing fabrics of the composite material. The intended shielding of airplane equipment and systems (metal boxes, metal meshes, etc.) is also required.

Current solutions partially solve the problem and require combining several of them to comply with all the requirements. The solution considered in the present invention complies with all the required functionalities, all of this with a suitable cost and weight. It also allows its combination with any of them to form the optimal design solution.

### SUMMARY OF THE INVENTION

According to a first aspect, the present invention thus proposes a non-conductive structural composite material component, particularly for aircraft (panel, frame, stringer, skin, spar, rib, etc.), which component comprises a metal surface add-on, such that said structural component together with the remaining metallized structural components can provide the aircraft structure (fuselage, wing, hulls . . . ) with sufficient conductive metal mass.

The aircraft structural component metallization system according to the invention could thus simplify or even substitute the currently used systems by means of exclusively using the proposed metallizing system or combining it with any of the other existing systems.

According to a second aspect of the invention, a metallization method is proposed in the manufacture of a non-conductive structural component, particularly of an aircraft, made of composite material, which method allows the geometric configuration of the add-on by applying it in an extensive or limited manner to predetermined contours by means of using templates. This constructive feature allows creating integrated electric circuits in the airplane structure by means of creating independent tracks with different widths and thicknesses.

Other features and advantages of the present invention will be understood from the following detailed description of an illustrative embodiment, by way of a non-exhaustive example, of its object in relation to the attached figures.

### DESCRIPTION OF THE DRAWINGS

FIG. 1 shows a diagram of the structural composite material component with a metal surface add-on according to the present invention.

FIG. 2 shows a diagram of the section according to A-A of the structural composite material component with a metal surface add-on according to the present invention.

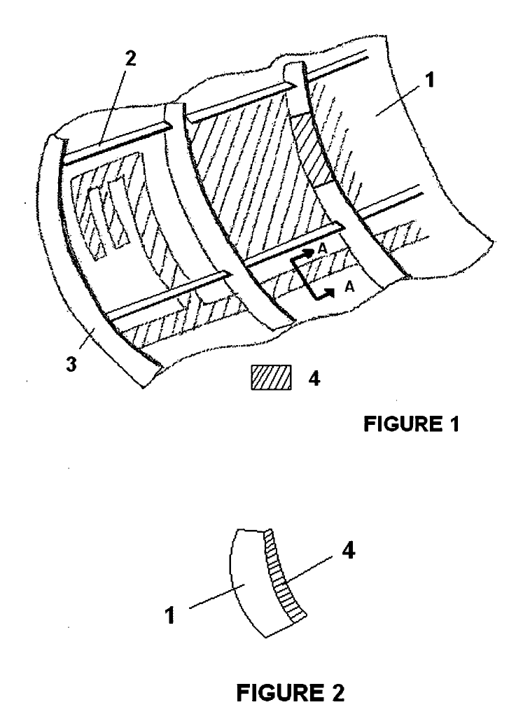

### DETAILED DESCRIPTION OF THE INVENTION

The present invention thus proposes a non-conductive structural component, particularly for aircraft (panel 1, frame 3, stringer 2, etc), manufactured in composite material and in the surface of which a metal-type layer 4 is fixed, such that the mentioned component together with the remaining metallized components can provide the aircraft with the conductive metal mass for any or several of the following functions:
current return and signal (grounding)
leakage current return path (bonding)
electric signal reference (low impedance ground plane)
electric circuit
electromagnetic field protection (HIRF)
antenna ground plane
lightning and electric discharge (even electrostatic discharge) protection: systems, structure, passengers, etc.

This solution is carried out by means of a surface metallizing process referred to as “metal spraying”, the technology and installations of which are used for the surface protection of several types of surfaces. This process consists of melting, preferably by electric arc, a rod made of aluminium, copper or another metal in an intense inert gas flow, which generates a fine molten metal spray ejected through a nozzle which firmly adheres to the surface in question. The previous metal spraying process is a surface coating process whereby molten or semi-molten coating materials in fine metal or non-metal particles are sprayed on a prepared substrate material.

The coating material can be provided in a rod, in powder, in a cord or in a cable with a core. The thermal spraying equipment generates the necessary heat together with a combination of gases and an electric arc. When the coating material particles melt, they are projected at speed such that they form a spraying flow onto the substrate material to be treated. When the particles reach the substrate material, they form a series of planar layers combining to form a laminar structure.

The molten material flow solidifies on the surface of the component to form a dense coating strongly adhered thereto.

One of the main advantages of this process is that the coatings can be used almost immediately without curing or drying times, there being no risk of damaging the component. The coatings further have a high level of fixing to the substrate material while at the same time the use of only compressed air and electricity makes the structural components more cost-effective.

If a template is placed in the path of this spray, any metallized surface could be obtained after one or several layers with different templates could be obtained, which surface firmly adheres to the skin and has the most convenient design, thickness and extension. The use of this template is optional.

An electric circuit system could further be integrated by the same process, spraying a uniform layer or multiple layers, masking (or not masking) the required areas.

It is important to indicate that the application of this metallization can only be carried out in certain areas of the structural component, or can be carried out in the entire non-conductive structural component. The metallized surface can also have any geometric shape and can even comprise thickness variations according to needs. Metallization can also be carried out in all the faces of the structural components or parts to be metallized or in only some of them.

According to a second aspect of the invention, a metallization method is proposed in the manufacture of a structural component, particularly for aircraft, made of composite material, which method allows the geometric configuration of the add-on by applying it in an extensive or limited manner to predetermined contours by means of using templates. This constructive feature allows creating integrated electric circuits in the airplane structure by means of creating independent tracks with different widths and thicknesses.

The process comprises the following steps:
a) preparing a template, if the use thereof is required
b) in the event of using a template, placing the template on the non-conductive structural component
c) spraying by means of metal spraying on the template that is arranged in turn on the non-conductive structural component
d) solidifying the sprayed molten material
e) removing the template from the non-conductive structural component

The previous constructive feature allows creating integrated electric circuits in the airplane structure by means of creating independent tracks with different widths and thickness, using a process similar to that descried and by means of using suitable templates.

The invention can be applied to structures formed by different components (frame, stringer, panel, . . . ) which have been previously manufactured according to their own process and joined in the final assembly process, or to integral structures in which all the different components are manufactured simultaneously, being joined in a single manufacturing process, forming part of a single structural part or integral component. It can also be applied to combinations of both types of structure.

The modifications comprised within the scope defined by the following claims can be introduced in the preferred embodiment which has just been described.

1. A non-conductive structural component manufactured in composite material, characterized in that the surface of said component comprises a metal-type layer (4) fixed by means of the metal spraying process, such that the structural component provides the assembly in which it is arranged with the necessary conductive metal mass.

2. A non-conductive structural component manufactured in composite material, characterized in that in the metal spraying process a template is placed in the spray between the structural component and discharger of the mentioned spray.

3. A non-conductive structural component manufactured in composite material according to claim 1, characterized in that the metal-type layer (4) is arranged only in certain areas of the mentioned structural component.

4. A non-conductive structural component manufactured in composite material according to claim 1, characterized in that the metal-type layer (4) is arranged in the entire assembly of the mentioned structural component.

5. A non-conductive structural component manufactured in composite material according to claim 1, characterized in that the layer (4) comprises thickness variations.

6. A non-conductive structural component manufactured in composite material according to claim 1, characterized in that the structural component is of an aircraft.

7. A non-conductive structural component manufactured in composite material according to claim 6, characterized in that the structural component is an aircraft panel (1).

8. A non-conductive structural component manufactured in composite material according to claim 6, characterized in that the structural component is an aircraft frame (3).

9. A non-conductive structural component manufactured in composite material according to claim 6, characterized in that the structural component is an aircraft stringer (2).

10. A non-conductive structural component manufactured in composite material according to claim 6, characterized in that the structural component is a spar.

11. A non-conductive structural component manufactured in composite material according to claim 6, characterized in that the structural component is a rib.

12. A non-conductive structural component manufactured in composite material according to claim 6, characterized in that the structural component is a skin.

13. A non-conductive structural component manufactured in composite material according to claim 6, characterized in that the structural component forms an integral component.

14. A method for manufacturing a non-conductive structural component manufactured in composite material comprising a metal-type layer (4) fixed by means of the metal spraying process, such that the structural component provides the assembly in which it is arranged with the necessary conductive metal mass, which method comprises the following steps:
a. spraying by means of metal spraying on the template which is arranged in turn on the non-conductive structural component
b. solidifying the sprayed molten material
c. removing the template from the non-conductive structural component.

15. A method for manufacturing a non-conductive structural component manufactured in composite material according to claim 14, characterized in that it further comprises the steps of:
a. preparing a template
b. placing the template on the non-conductive structural component

16. A method for manufacturing a non-conductive structural component manufactured in composite material according to claim 14, characterized in that it allows creating integrated electric circuits by means of creating independent tracks with different widths and thicknesses.

17. A method for manufacturing a non-conductive structural component manufactured in composite material according to claim 14, characterized in that the metal-type layer (4) is only arranged in certain areas of the mentioned structural component.

18. A method for manufacturing a non-conductive structural component manufactured in composite material according to claim 14, characterized in that the metal-type layer (4) is arranged in the entire assembly of the mentioned structural component.

19. A method for manufacturing a non-conductive structural component manufactured in composite material according to claim 14, characterized in that the layer (4) comprises thickness variations.

20. A method for manufacturing a non-conductive structural component manufactured in composite material according to claim 14, characterized in that the structural component is of an aircraft.

21. A method for manufacturing a non-conductive structural component manufactured in composite material according to claim 20, characterized in that at least one of the structural component is an aircraft panel (1), or the structural component is an aircraft frame (3), or the structural component is an aircraft stringer (2).

22. (canceled)

23. (canceled)

24. A method for manufacturing a non-conductive structural component manufactured in composite material according to claim 20, characterized in that the structural component is a spar.

25. A method for manufacturing a non-conductive structural component manufactured in composite material according to claim 20, characterized in that the structural component is a rib.

26. A method for manufacturing a non-conductive structural component manufactured in composite material according to claim 20, characterized in that the structural component is a skin.

27. A method for manufacturing a non-conductive structural component manufactured in composite material according to claim 20, characterized in that the structural component forms an integral component.
